(19) United States
(12) Patent Application Publication
(10) Pub. No.: US 2013/0109240 A1
(43) Pub. Date: May 2, 2013

(54) CARD EDGE CONNECTOR

(71) Applicant: Ming -Huang Chiang, Taipei City (TW)

(72) Inventor: Ming -Huang Chiang, Taipei City (TW)

(21) Appl. No.: 13/286,233

(22) Filed: Nov. 1, 2011

(51) Int. Cl. H01R 24/00

(52) U.S. Cl. 439/630

(57) ABSTRACT

A card edge connector for receiving and retaining an interface card having two pin holes mainly includes a base and two elastic arms. The base is arranged to a main board, and a slot is formed to a front side thereof. The interface card is inclined inserted into the slot and pushed to parallel the main board. The two elastic arms are arranged symmetrically to the base. A buckle and a positioning portion are formed to a lateral side of the elastic arm. The buckles serve to buckle two lateral sides of the interface card, and the positioning portion has a positioning pin being inserted into the pin hole of the interface card. Through the components, the improved card edge connector of low manufacture cost is capable of retaining the card from escaping.

### FIELD OF THE INVENTION

The present invention relates to connectors for interface card such as a memory module, and particular to an improved card edge connector of low manufacture cost which is capable of preventing the inserted interface card from escaping.

### DESCRIPTION OF THE PRIOR ART

With the limitation in height of laptop, card edge connectors in laptop are designed to be inclined inserted by interface cards such as memory module and the inserted card can be pushed down to parallel the main board. Referring to FIG. 1, a prior card edge connector is illustrated. It includes an insulated base 10. The base 10 has a slot 11 formed to a lateral side thereof. An interface card 15 is inclined inserted into the slot and pushed horizontally. Two elastic arms 12 are extending from two lateral sides of the slot 11 respectively. The elastic arm 12 has a buckle 13 and a positioning portion 14. The buckle 13 serves to buckle two lateral sides of the horizontal card on top so as to retain the interface card 15 from raising up. The positioning portion 14 is a half dome serving to inwards clamp two semicircular notches 16 formed the two lateral sides of the interface card 15 so as to hold the interface card 15. However, the two elastic arms 12 are usually made of insulated material such as plastic, such assembly and the elasticity are weak. The positioning portions 14 clamp the interface card 15 from the outside so that the clamping is easily loose by vibration or collision during operation or transportation and result in malfunction.

To solve above disadvantages, an enhancement of metal sheet added to the elastic arm or a partial, entire replacement by a bent metal sheet are developed in Taiwan published patents of M293577-M335063-M364335. However, the assembly of better strength and elasticity still suffers elastic fatigue after a period of time. Moreover, such enhancement will complicate the process and cause a higher cost.

Therefore, based on thoughtful conceptions and constructive improvement, the inventor provides the present invention against the disadvantages of the prior art.

### SUMMARY OF THE PRESENT INVENTION

Accordingly, the primary object of the present invention is to provide an improved card edge connector of low manufacture cost which is capable of preventing the inserted interface card from escaping. The improved card edge connector of the present invention serves to retain an interface card having two pin holes. Through two positioning pins of two elastic arms inserted into two pin holes of the interface card, the interface card will be retained inside the slot for long period. In the present invention, a base and the two elastic arms can be formed integrally so as to simply the manufacture and assembling and to lower the cost as well.

### BRIEF DESCRIPTION OF THE DRAWINGS

FIG. 1 is a schematic view showing a prior card edge connector.

FIG. 2 is an exploded view of a first embodiment of the present invention.

FIG. 3 is a schematic view showing the first embodiment of the present invention arranged to a main board.

FIG. 4 is a cross-section view showing a connection of a base and an elastic arm of the present invention.

FIG. 5 is a schematic view showing the first embodiment with an inserted interface board.

FIG. 6 is a schematic view showing an insertion of the first embodiment of the present invention.

FIG. 7 is a schematic view showing another operation of the first embodiment of the present invention.

FIG. 8 is a cross-section view showing the connection shown in FIG. 7.

FIG. 9 is a schematic view showing an insertion of a second embodiment of the present invention.

FIG. 10 is a schematic view showing the second embodiment of the present invention with an inserted interface board.

FIG. 11 is a top view showing the second embodiment of the present invention.

FIG. 12 is a schematic view showing an insertion of a third embodiment of the present invention.

FIG. 13 is a cross-section view of the third embodiment of the present invention.

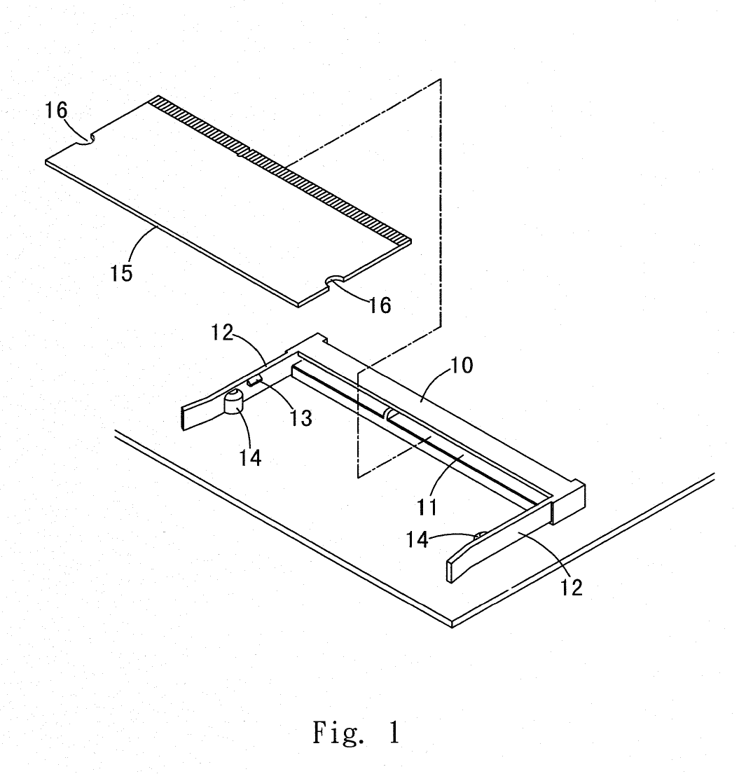

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

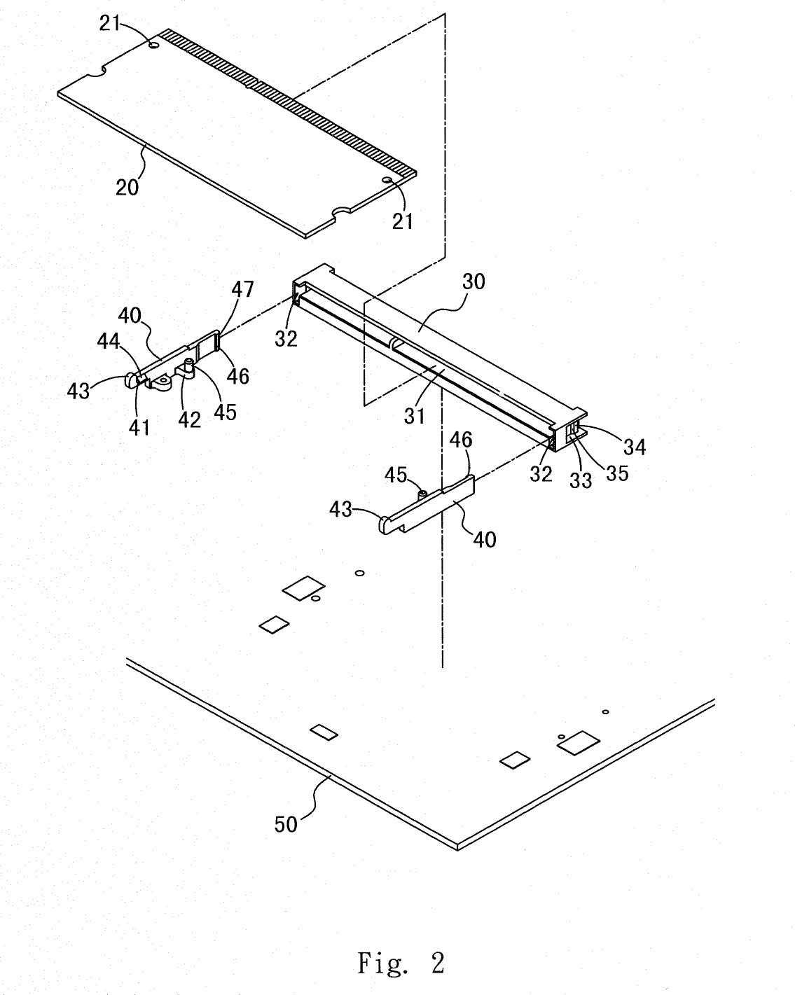

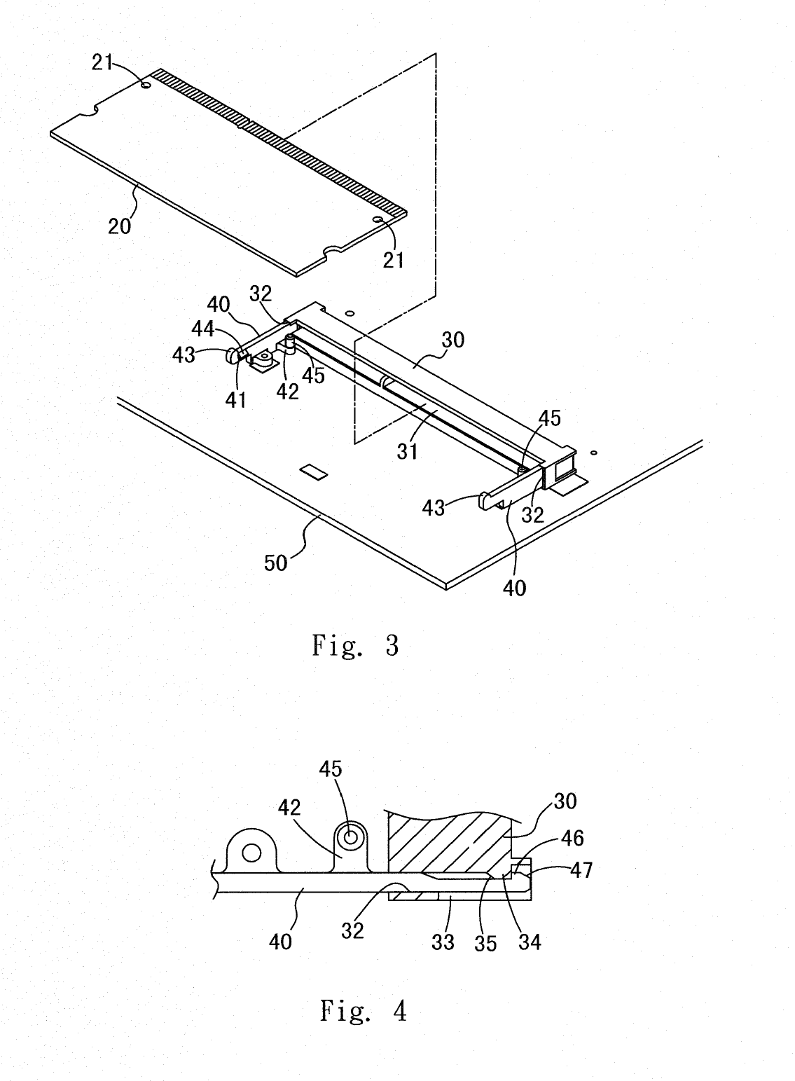

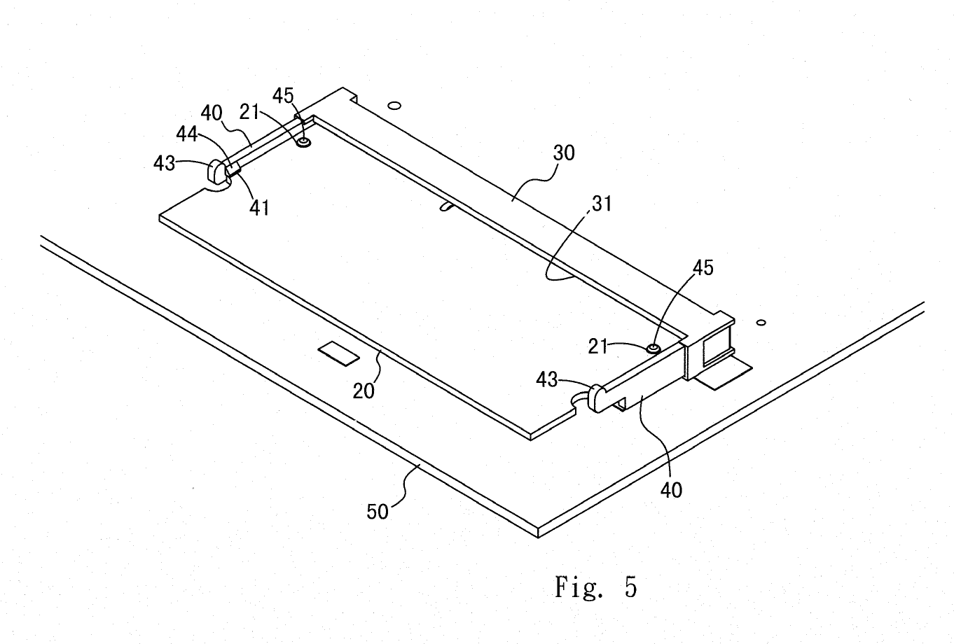

Referring to FIGS. 2 to 6, a first embodiment of an improved card edge connector according to the present invention serves to clamp an interface card 20 and prevent the interface card 20 from escaping. The interface card 20 has two pin holes 21, and the improved card edge connector mainly includes a base 30 and two elastic arms 40.

The base 30 is embedded to a main board 50. The base 30 made of plastic has a slot 31 and two retaining holes 32 on two later side thereof. The interface card 20 is inclined inserted into the slot 31 and pushed to parallel the mother board 50.

The elastic arm 40 is made of plastic, and an end thereof is inserted into the retaining hole 32. The elastic arm 40 has a buckle 41, positioning portion 42, and a protruding sheet 43. The buckle 41 is formed to an inner side of the elastic arm 40. A slope 44 is formed to an upper surface of the buckle 40 to guide the lateral of the interface card 20 so that the lateral of the interface card 20 can be smoothly pushed below the buckle 41. Thus the interface card 20 is buckled by the buckle 41 and will not raise up from the base 30. The positioning portion 42 is formed to the inner side of the elastic arm 40. A positioning pin 45 formed to an upper surface of the positioning portion 42 will be inserted into the pin hole 21 of the interface card 20 so as to prevent the interface card 20 from escaping out of the slot 31. The protruding sheet 43 is formed to an upper portion of the other end of the elastic arm 40 so as to be stirred by user. The upper end of the positioning pin 45 is formed as a cone so that the pin hole 21 of the interface board 20 can be smoothly slide to the positioning pin 45.

Referring to FIGS. 2 and 4, a notch 33 communicating with the retaining hole 32 is formed to two lateral sides of the base 30. A bump 34 opposite to the notch 33 is formed to a wall of the retaining hole 32. A front surface of the bump 34 has an inclined surface 35. The end of the elastic arm 40 inserted to the retaining hole 32 has a hook 46 serving to hook a rear side of the bump 34. A guiding surface 47 is formed to a front end of the hook 46 for guiding the hook 46 through the inclined surface 35 so that the hook 46 can smoothly hook the rear side of the bump 34. In the present invention, the elastic arm 40 and the base 30 are formed integrally.

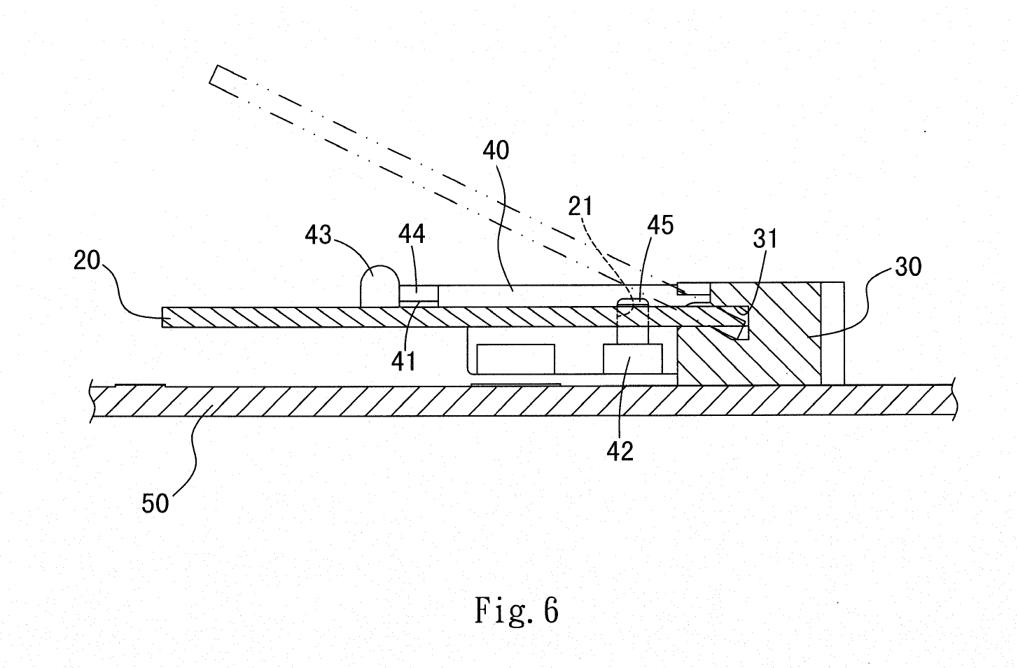

Referring to FIG. 6, the front of the interface card 20 is inclined inserted into the slot 31. Then, the interface card 20 is pushed to parallel the main board 50. When the interface card 20 is pushed downward, the laterals of the interface card 20 will slide through the slope 44 and push out the elastic arms 40 slightly. When the laterals of the interface card 20 are pushed below the buckles 41, the buckles 41 will retain the laterals of the interface card 20 so as to hold the interface card 20 in the slot 31. To remove the interface card 20 from the slot 31, the protruding sheets 43 are stirred aside so as to move the buckles 41 away from the laterals of the interface card 20. Then, the rear side of the interface card 20 can be raised up from the slot 31 to be retrieved.

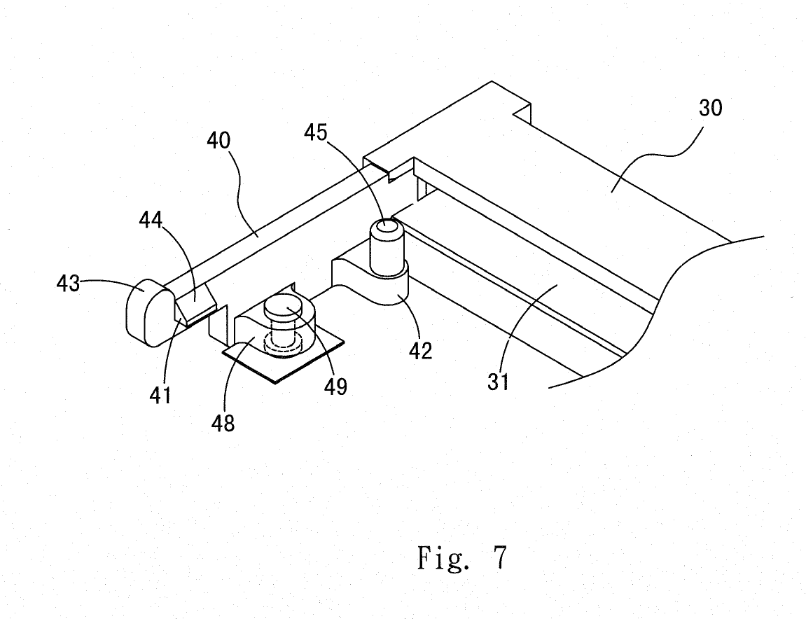

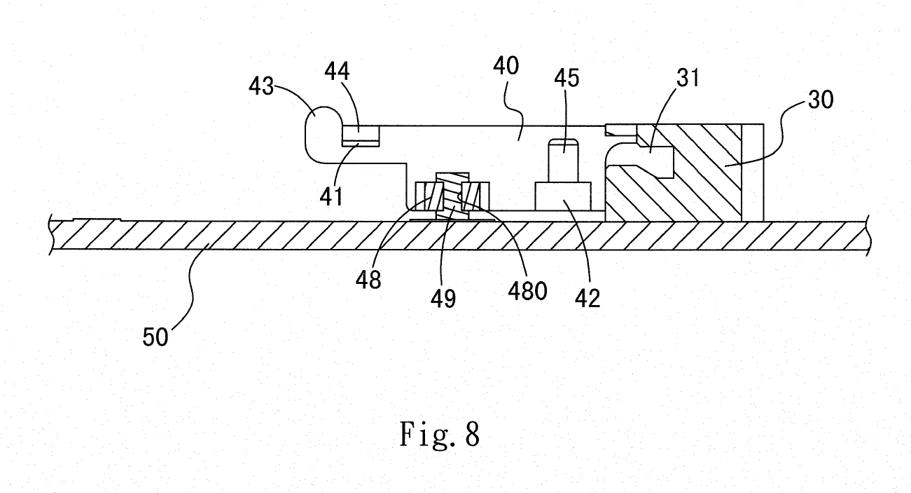

Referring to FIGS. 7 and 8, another operation of the present invention is illustrated. A support 48 is formed to the inner side of the elastic arm 40. A through hole 480 is formed to the support 48 for receiving a column 49. The column 49 is fixed to the main board 50 so that the strength of the structure and the force of buckling of the elastic arm 40 can be enhanced by the support of the column 49.

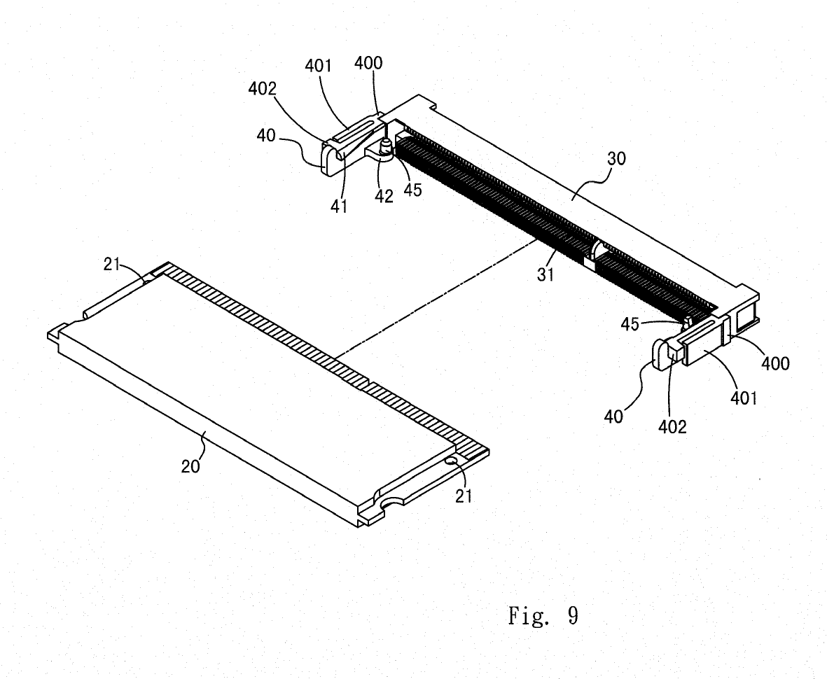

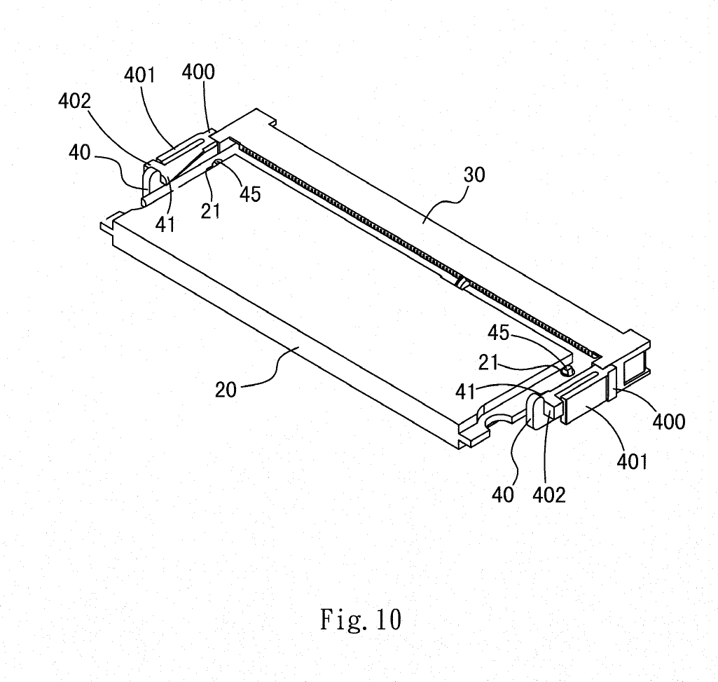

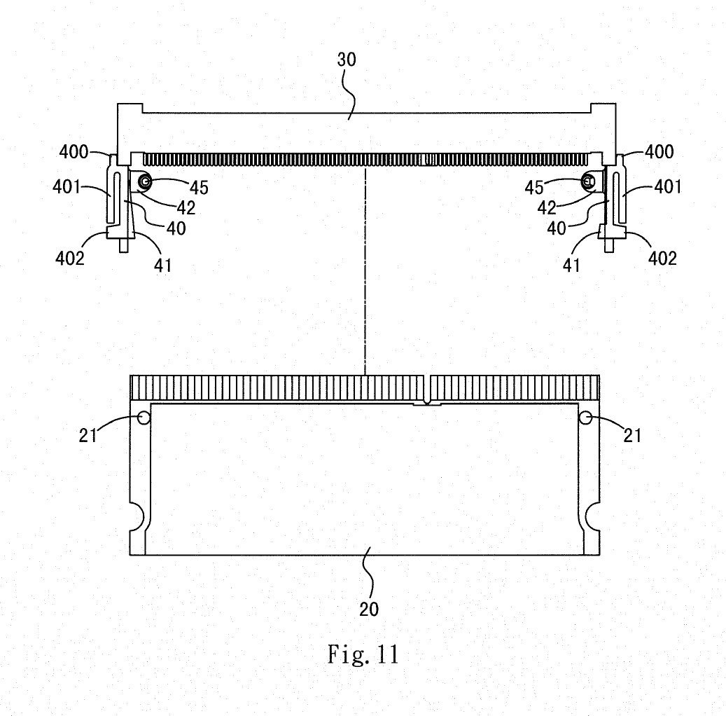

Referring to FIGS. 9 to 11, a second embodiment of the present invention is illustrated. The difference between the two embodiments is the second embodiment has a clamp 400, a stop 401, and a block 402 extending from an outer side of the elastic arm 40. The clamp 400 extends to an outer side of the base 30 so as to clamp the base 30. The stop 401 extending from the junction of the elastic arm 40 and the base 30 is parallel to the elastic arm 40 with a predetermined gap. The block 402 is formed to the outer side of the elastic arm 40 opposite to the buckle 41. Through the above components, the elasticity of the elastic arm 40 will be enhanced and the range of the deformation to the elastic arm 40 can be limited so as to prevent breakage due to excessive deformation. An upper surface of the buckle 41 is an arc surface to guide the lateral of the interface card 20 so that the laterals of the interface card 20 can be smoothly pushed below the buckles 41. A slope is formed to a portion of the cone end of the positioning pin 45 so that the pin holes 21 of the interface board 20 can be smoothly slide to the positioning pins 45.

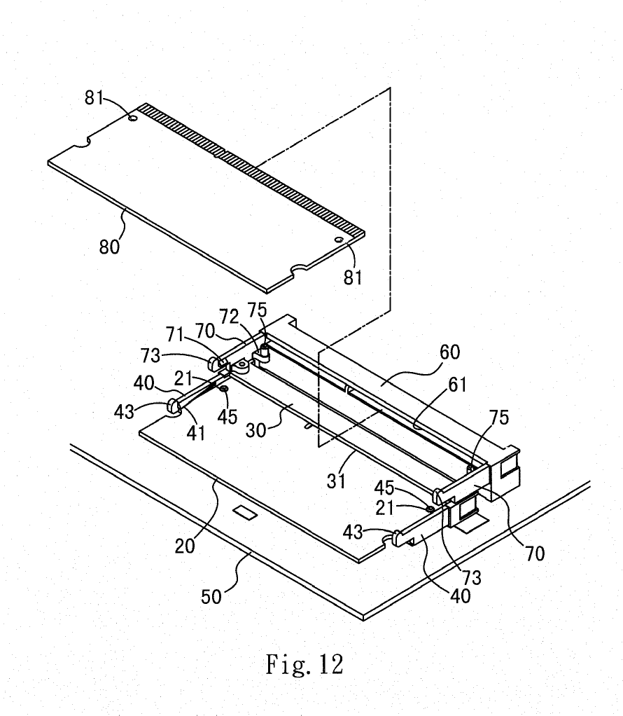

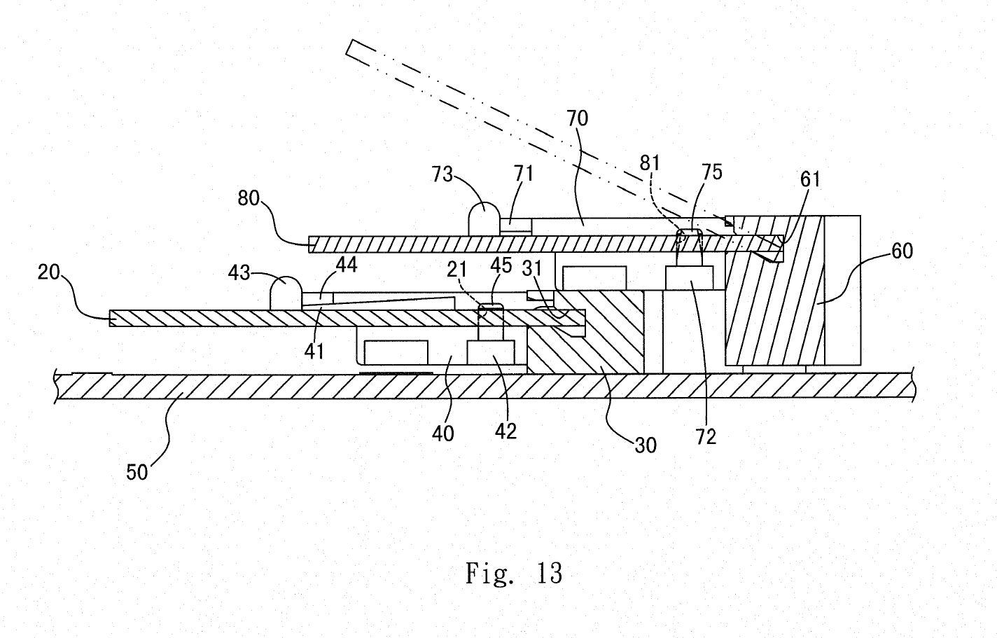

Referring to FIGS. 12 and 13, a third embodiment of the present invention is illustrated. Including the components mentioned in above embodiments, a second base 60 and two second elastic arms 70 are added to the embodiment. The second base 60 is fixed to the main board 50 following the base 30. The second base 60 has a second slot 61 on a front thereof, the second slot 61 higher than the base 30 serves to receive a second interface card 80. The second interface card 80 is inclined inserted into the second slot 61 and pushed to parallel the mother board 50. The second interface card 80 has two second pin holes 81. The second elastic arm 70 having a second buckle 71, second positioning portion 72, and a second protruding sheet 73 is the same as the elastic arm 40. The second buckle 81 serves to buckle the lateral of the second interface card 80. A second positioning pin 75 formed to an upper surface of the second positioning portion 72 will be inserted into the second pin hole 81 of the second interface card 80. The second protruding sheet 73 is formed to an end of the second elastic arm 70. The connection between the second elastic arm 70 and the second base 60 is the same as the way between the elastic arm 40 and the base 30.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A card edge connector for receiving and retaining an interface card having two pin holes comprising:
a base arranged to a main board; a slot being formed to a front side of the base; the interface card being inclined inserted into the slot and pushed to parallel the main board; and
two elastic arms arranged symmetrically to the base; a buckle and a positioning portion being formed to an inner side of the elastic arm; the buckles buckling two lateral sides of the interface card; a positioning pin formed to an upper surface of the positioning portion being inserted into the pin hole of the interface card.

2. The card edge connector as claimed in claim 1, wherein a slope is formed to an upper surface of the buckle to guide the lateral of the interface card so that the lateral of the interface card will be smoothly pushed below the buckle.

3. The card edge connector as claimed in claim 1, wherein an upper surface of the buckle has an arc surface to guide the lateral of the interface card so that the lateral of the interface card will be smoothly pushed below the buckle.

4. The card edge connector as claimed in claim 1, wherein a slope is formed to a portion of an upper end of the positioning pin.

5. The card edge connector as claimed in claim 1, wherein a protruding sheet is formed to an upper end of the elastic arm so as to be stirred by user.

6. The card edge connector as claimed in claim 1, wherein a support is formed to the inner side of the elastic arm; a through hole is formed to the support for receiving a column fixed to the main board.

7. The card edge connector as claimed in claim 1, wherein a stop is formed to an outer side of the elastic arm; the stop extending from the junction of the elastic arm and the base is parallel to the elastic arm with a predetermined gap.

8. The improved card edge connector as claimed in claim 1, wherein the base has two retaining holes on two lateral sides of the slot; the two elastic arms are inserted into the retaining holes respectively; a notch communicating with the retaining hole is formed to two lateral sides of the base respectively; a bump opposite to the notch is formed to a wall of the retaining hole; a front surface of the bump has an inclined surface; the end of the elastic arm inserted to the retaining hole has a hook serving to hook a rear side of the bump; a guiding surface is formed to a front end of the hook for guiding the hook through the inclined surface to the rear side of the bump.

9. The card edge connector as claimed in claim 8, wherein the elastic arm has a clamp extending to an outer side of the base.

10. The card edge connector as claimed in claim 9 further comprising a second base and two second elastic arms; the second base being fixed to the main board following the base; the second base having a second slot on a front side thereof, the second slot higher than the base serving to receive a second interface card; the second interface card being inclined inserted into the second slot and being pushed to parallel the mother board; the second interface card having two second pin holes; the two second elastic arms being symmetrically arranged to the second base; the second elastic arm having a second buckle and a second positioning portion; the second buckle serving to buckle the lateral of the second interface card; a second positioning pin formed to an upper surface of the second positioning portion being inserted into the second pin hole of the second interface card.

11. The card edge connector as claimed in claim 1, wherein the base and the two elastic arms are formed integrally.

12. The card edge connector as claimed in claim 11 further comprising a second base and two second elastic arms; the second base being fixed to the main board following the base; the second base having a second slot on a front side thereof, the second slot higher than the base serving to receive a second interface card; the second interface card being inclined inserted into the second slot and being pushed to parallel the mother board; the second interface card having two second pin holes; the two second elastic arms being symmetrically arranged to the second base; the second elastic arm having a second buckle and a second positioning portion; the second buckle serving to buckle the lateral of the second interface card; a second positioning pin formed to an upper surface of the second positioning portion being inserted into the second pin hole of the second interface card.
